(19) United States
(12) Patent Application Publication
(10) Pub. No.: US 2026/0109470 A1
(43) Pub. Date: Apr. 23, 2026

(54) METHOD AND MODULE FOR DETECTING THE STATE OF A COUPLING DEVICE, AND ASSOCIATED TURBINE ENGINE AND AIRCRAFT

(71) Applicant: SAFRAN AIRCRAFT ENGINES, Paris (FR)

(72) Inventors: Irène Bujon, MOISSY CRAMAYEL (FR); Vincent Christophe Brodbeck, MOISSY CRAMAYEL (FR)

(73) Assignee: SAFRAN AIRCRAFT ENGINES, Paris (FR)

(21) Appl. No.: 19/121,796

(22) PCT Filed: Oct. 10, 2023
(86) PCT No.: PCT/FR2023/051569

§ 371 Date: Apr. 16, 2025

(30) Foreign Application Priority Data
Oct. 20, 2022 (FR) FR2210868

(51) Int. Cl. B64D 35/022; B64D 27/33; B64D 45/00; F01D 15/00

(52) U.S. Cl. CPC B64D 35/022; B64D 27/33; B64D 45/00; F01D 15/00; B64D 2045/0085

(57) ABSTRACT

This method for controlling the operation of a coupling device for an aircraft turbomachine comprises the steps of:
a first comparison of the determined rotational speed of an electric machine with a time evolution profile, the first comparison being carried out to determine an operating deviation;
a second comparison of the operating deviation with a detection threshold; and
according to the result of the second comparison step, identifying the existence or absence of a failure of the coupling device;
the second comparison step comprising determining the value of the detection threshold from at least one control parameter, the operating deviation and the rotational speed of the electric machine.

### TECHNICAL FIELD

The invention relates to detecting the operating state of a coupling device connecting two shafts together.

The invention relates more specifically to a module for controlling the operation of the coupling device, a turbomachine comprising a coupling device and such a module, an aircraft comprising such a turbomachine and a method for controlling the operation of the coupling device.

### PRIOR ART

An aircraft is generally provided with a turbomachine comprising at least one rotary shaft, at least one gas turbine, at least one compressor and a combustion chamber.

The turbomachine may comprise an electric machine, for example with permanent magnets.

As long as the rotor of the electric machine rotates, the magnets generate an electromotive force.

During a short circuit, the current generated by the electromotive force causes heating of the loop through which the current flows, which is likely to cause a fire on board the aircraft.

It is known to add a coupling device connecting a rotor shaft of the electric machine to a drive shaft of the turbomachine to detach the drive shaft from the rotor shaft of the electric machine.

In order to ensure a high level of availability and operational reliability of the coupling device, it is necessary to periodically control its operation to ensure that when a disconnection command is given, the coupling device separates the drive shaft and the rotor shaft. In particular, during a disconnection instruction following the detection of a failure of the electric machine, it is necessary to have a confirmation of the disconnection of the coupling device. It is therefore necessary to have an adaptive method for checking the operating state of the coupling device.

### DESCRIPTION OF THE INVENTION

The present invention aims to overcome all or part of these disadvantages.

The present invention relates to a method for controlling the operation of a coupling device for an aircraft turbomachine, the turbomachine comprising a rotary shaft and an electric machine, the coupling device being configured to connect a rotor shaft of the electric machine to the rotary shaft and having two operating states, a coupled state so as to secure the rotor shaft and the rotary shaft and a decoupled state so as to separate the rotor shaft and the rotary shaft, the method comprising the following steps:
determining a control state of the coupling device;
determining the rotational speed of the electric machine;
determining the rotational speed of the rotary shaft;
a first comparison of the determined rotational speed of the electric machine with a time evolution profile of the rotational speed of the electric machine determined from the rotational speed of the rotary shaft and the control state of the coupling device, the first comparison being carried out to determine an operating deviation;
a second comparison of the operating deviation with a detection threshold; and
according to the result of the second comparison step, identifying the existence or absence of a failure of the coupling device;
the second comparison step comprising determining the value of the detection threshold from at least one control parameter, the operating deviation and the rotational speed of the electric machine.

By determining the value of the detection threshold as a function of the control parameter, the operating deviation and the rotational speed of the electric machine, the operating conditions of the turbomachine can be taken into account in order to improve the detection of a failure of the coupling device.

Advantageously, the control parameter is selected from the outside temperature, the altitude of the aircraft and a parameter representative of a type of failure of the electric machine.

Optionally, the first comparison step comprises a prior step of determining a chart of time evolution profiles of the rotational speed of the electric machine as a function of the rotational speed of the rotary shaft and the control state of the coupling device.

Advantageously, the second comparison step comprises calculating the gradient of the operating deviation and a step of calculating the gradient of the time evolution profile prior to the second comparison step, the value of the detection threshold being determined from the control parameter, the gradient of the operating deviation, and the gradient of the determined rotational speed of the electric machine.

Advantageously, the method comprises a step of delaying the result of the second comparison step.

Optionally, the method comprises prior to the step of determining the rotational speed of the electric machine, a control of the electric machine in motor mode when the turbomachine is stopped.

Optionally, the method comprises blocking the rotation of the rotary shaft when the electric machine operates in motor mode.

The present invention also relates to a module for controlling the operation of a coupling device for an aircraft turbomachine, the turbomachine comprising a rotary shaft and an electric machine, the coupling device being configured to connect a rotor shaft of the electric machine to the rotary shaft and having two operating states, a coupled state so as to secure the rotor shaft and the rotary shaft and a decoupled state so as to separate the rotor shaft and the rotary shaft, the method comprising:
first determining means configured to determine a control state of the coupling device;
second determining means configured to determine the rotational speed of the electric machine,
third determining means configured to determine the rotational speed of the rotary shaft;
first comparison means configured to compare the rotational speed of the electric machine with a time evolution profile of the rotational speed of the electric machine determined from the rotational speed of the rotary shaft and the control state of the coupling device, the first comparison means being configured to determine an operating deviation;
second comparison means configured to compare the operating deviation with a detection threshold; and
means for determining a failure configured to identify the existence of a failure or absence of a failure of the coupling device according to the result delivered by the second comparison means;
the second comparison means also being configured to determine the value of the detection threshold from at least one control parameter, the operating deviation and the rotational speed of the electric machine.

The present invention also relates to an aircraft turbomachine comprising a rotary shaft, an electric machine, and a coupling device configured to connect a rotor shaft of the electric machine to the rotary shaft and having two operating states, a coupled state so as to secure the rotor shaft and the rotary shaft and a decoupled state so as to separate the rotor shaft and the rotary shaft, the turbomachine comprising a control module as defined above.

Finally, the present invention relates to an aircraft comprising a turbomachine as defined above.

### BRIEF DESCRIPTION OF THE DRAWINGS

Other aims, features and advantages of the invention will become apparent upon reading the following description, provided solely as a non-limiting example and with reference to the appended drawings wherein:

FIG. 1 schematically shows an aircraft according to the invention;

FIG. 2 schematically shows a control module according to the invention; and

FIG. 3 schematically shows a method for controlling the operation of a coupling device of an aircraft turbomachine according to the invention.

### DETAILED DESCRIPTION

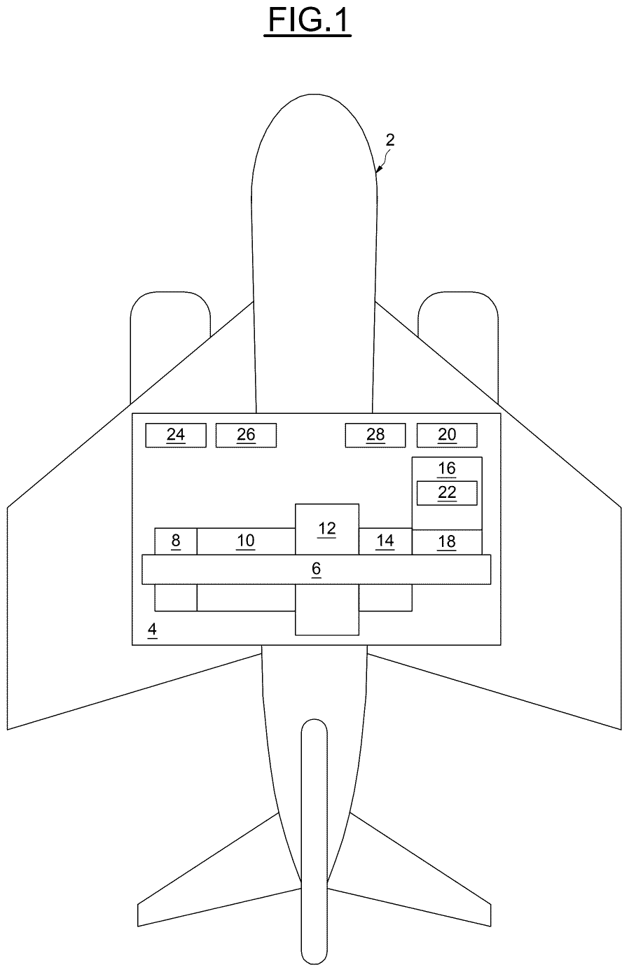

FIG. 1 schematically shows an aircraft 2 comprising a turbomachine 4, the aircraft 2 being for example an aeroplane, a helicopter or a vertical take-off and landing aircraft.

The turbomachine 4 comprises at least one rotary shaft, here a rotary shaft 6 on which a fan 8, a compressor 10, a combustion chamber 12 and a turbine 14 are mounted.

The turbomachine 4 comprises an electric machine 16 and a coupling device 18 connecting the rotor shaft of the electric machine 16 to the rotary shaft 6, for example via a gearbox having a predetermined transmission ratio. However, the coupling device 18 can directly connect the rotor shaft of the electric machine 16 to the rotary shaft 6.

The electric machine 16 comprises, for example, a permanent magnet synchronous machine associated with a power electronics converter or an electromagnet machine. The electric machine 16 comprises a rotor shaft (not shown).

Alternatively, the electric machine 16 has a wound rotor.

The coupling device 18 comprises two operating states, namely a so-called ‘coupled’ state in which the rotor shaft and the rotary shaft 6 are connected and a so-called ‘decoupled’ state in which the rotor shaft and the rotary shaft 6 are disconnected.

The turbomachine 4 further comprises a control device 20 capable of controlling the coupling device 18 such that the coupling device 18 is in a coupled or decoupled state.

The electric machine 16 comprises a diagnostic sensor 22. By way of example, the diagnostic sensor 22 may be a temperature sensor capable of detecting overheating of the electric machine 16, a force sensor capable of detecting a bearing failure of the electric machine 16, an electrical sensor capable of detecting a short circuit of the electric machine 16, a pressure sensor or an oil level sensor.

Alternatively, the diagnostic sensor 22 can be considered as a set of different sensors selected from the temperature sensor, the force sensor, the pressure sensor, the oil level sensor and the electrical sensor, for example.

Furthermore, the turbomachine 4 comprises a temperature sensor 24 capable of measuring the temperature outside the turbomachine 4 and an altitude sensor 26 capable of measuring the altitude at which the turbomachine 4 is located.

The coupling device 18 is controlled by a control module 28.

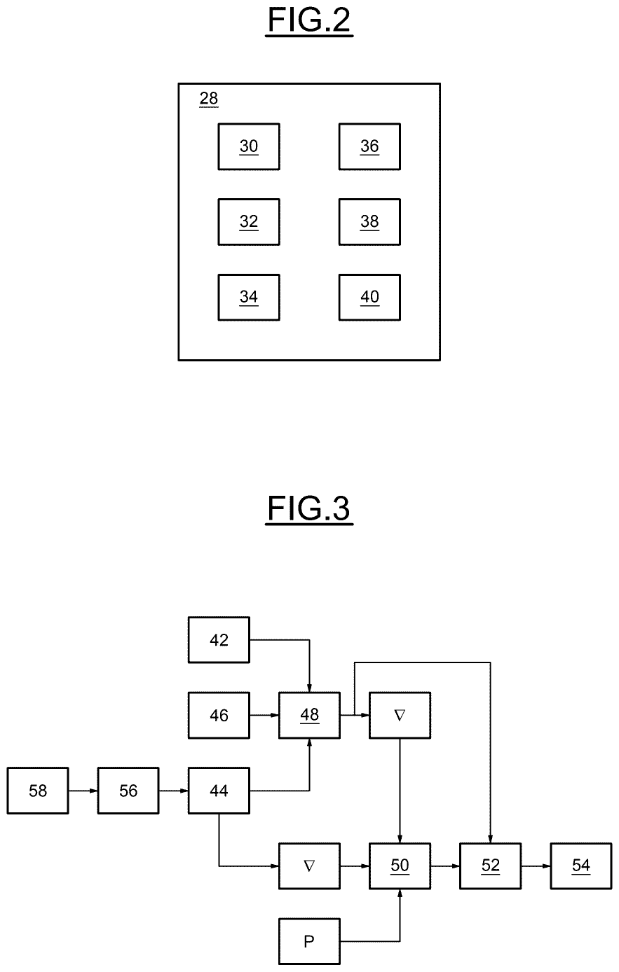

This control module 28 comprises, as illustrated in FIG. 2, first means 30 for determining the control state of the coupling device 18, second determining means 32 capable of determining the rotational speed of the electric machine 16, third determining means 34 capable of determining the rotational speed of the rotary shaft 6.

The first determining means 30 are, for example, electronically connected to the control device 20.

The second determining means 32 comprise, for example, a rotational speed sensor capable of measuring the rotational speed of the rotor shaft of the electric machine 16.

The third determining means 34 comprise, for example, a rotational speed sensor capable of measuring the rotational speed of the rotary shaft 6.

The control module 28 further comprises first comparison means 36 configured to compare the rotational speed of the electric machine 16 with a time evolution profile of the rotational speed of the electric machine 16 determined from the rotational speed of the rotary shaft 6 and the control state of the coupling device 18. The first comparison means 36 are thus configured to determine an operating deviation.

These first comparison means 36 may comprise a software architecture intended to implement a comparison algorithm. Such first comparison means 36 may be in the form of logic circuits forming a comparator for example.

Second comparison means 38, for example in the form of a comparator or a software architecture integrating a second comparison algorithm, ensure the comparison between the operating deviation and a detection threshold.

The second comparison means 38 determine the value of the detection threshold from at least one control parameter P, the operating deviation and the rotational speed of the electric machine 16.

The control module 28 comprises means for determining a failure 40, for example software means, configured to identify the existence or absence of a failure of the coupling device 18 according to the result delivered by the second comparison means 38. They are electronically connected to an indicator light or an alarm system, which may be audible, of the aircraft 2 to warn an operator of the failure. Optionally, the means for determining a failure 40 are capable of stopping the turbomachine 4 in the event of detection of a failure of the state change of the coupling device 18, the electric machine 16 no longer rotating when the turbomachine 4 is stopped.

FIG. 3 schematically shows a method for controlling the operation of the coupling device 18.

It is assumed that the combustion chamber 12 generates hot gases driving the turbine 14.

During a step 42 of determining the control state of the coupling device 18, the first determining means 30 and the control device 20 determine a control state of the coupling device 18. The control state of the coupling device 18 is delivered in the form of a control command in the coupled state or in the decoupled state of the coupling device 18.

During a step 44 of determining the rotational speed of the electric machine 16, a rotational speed sensor of the second determining means 32 measures the rotational speed of the rotor shaft of the electric machine 16. The rotational speed of the electric machine 16 is, for example, stored in a memory of the second determining means 32.

In the next step 46, the rotational speed of the rotary shaft 6 is determined. A rotational speed sensor of the third determining means 34 measures the rotational speed of the rotary shaft 6. The measured rotational speed of the rotary shaft 6 is, for example, stored in a memory of the third determining means 34.

The steps 42, 44, and 46 may be performed simultaneously or successively.

The first comparison means 36 therefore compare the rotational speed of the electric machine 16 with a time evolution profile of the rotational speed of the electric machine 16 determined from the rotational speed of the rotary shaft 6 and the control state of the coupling device 18 to determine an operating deviation (step 48).

The operating deviation is, for example, equal to the difference between the rotational speed of the electric machine 16 and the time evolution profile. This difference may be an instantaneous difference or a sum of the difference between the determined rotational speed of the electric machine 16 and the time evolution profile for a predetermined time.

The time evolution profile comprises the change in rotational speed of the rotary shaft 6 when the coupling device 18 is in a coupled state or the change in rotational speed of the rotary shaft 6 when the coupling device 18 is in a decoupled state. It is obtained, for example, from a reliable working model of the coupling device 18 or, for example, from a data sheet of the electric machine 16.

The time evolution profile is extracted from a chart of time evolution profiles of the rotational speed of the electric machine 16.

The chart is determined prior to the first comparison step as a function of the rotational speed of the rotary shaft 6 and the control state of the coupling device 18.

The chart of the time evolution profiles makes it possible to quickly determine the time evolution profile used during the first comparison step 48.

In the next step 50, the second comparison means 38 compare the operating deviation to a detection threshold.

The detection threshold is variable and is determined from a control parameter P, the operating deviation and the rotational speed of the electric machine 16.

The control parameter P comprises, for example, the temperature outside the aircraft 2 measured by the temperature sensor 24, the altitude of the aircraft 2 measured by the altitude sensor 26.

The temperature outside the aircraft 2 makes it possible to determine the viscosity of the oil of the electric machine 16 and/or the viscosity of the oil of the turbomachine 4.

When the viscosity of the cooling oil of the electric machine 16 is high, the electric machine 16 exhibits greater inertia. When the viscosity of the oil of the turbomachine 4 is high and the coupling device 18 is in a coupled state, the electric machine 16 exhibits greater inertia.

Taking into account the altitude of the aircraft 2 makes it possible to adjust the start-up time of the turbomachine 4.

The higher the altitude of the aircraft 2, the longer the start-up time of the turbomachine 4, for example 60 seconds at sea level to 120 seconds at high altitude.

The control parameter P may comprise a parameter representative of a type of failure of the electric machine 16.

For example, when overheating of the electric machine 16 is detected by the diagnostic sensor 22, the second comparison means 38 modify the threshold value to take account of the change in behaviour of the electric machine 16 as a result of the overheating. When the diagnostic sensor 22 detects a defective bearing of the electric machine 16, the second comparison means 38 modify the threshold value to take account of the change in behaviour of the electric machine 16 as a result of the failure of the bearing. When the diagnostic sensor 22 detects a short circuit in the electric machine 16, the second comparison means 38 modify the threshold value to take account of the change in behaviour of the electric machine 16. When the diagnostic sensor 22 detects an abnormal pressure or an abnormal oil level, the second comparison means 38 modify the threshold value to take account of the change in behaviour of the electric machine 16.

Of course, the parameter P may comprise a plurality of variables among the temperature outside the aircraft 2, the altitude of the aircraft 2 and the parameter representative of a type of failure.

Alternatively, the method comprises calculating the gradient (∇) of the operating deviation and a step of calculating the gradient of the time evolution profile prior to the second comparison step 50, the value of the detection threshold being determined from the control parameter P, the gradient of the operating deviation, and

The gradient of the time evolution profile of the rotational speed of the electric machine 16.

The use of gradients enables behavioural deviation to be detected quickly.

Depending on the result of the step 50, a failure of the coupling device 18 may be detected (step 52). If, for example, the operating deviation is greater than the variable detection threshold, the coupling device 18 is considered to be faulty. If the operating deviation is less than the detection threshold, the coupling device 18 is considered to be functional.

During a delay step 54, the result delivered by the second comparison means 38 is stored in a memory for a predetermined time and the steps 42, 44, 46, 48 and 50 are repeated, then the result delivered by the second comparison means 38 is compared with the result stored in the memory. If the two results are identical and representative of a failure, the means for determining a failure 40 report the failure. Otherwise, the means for determining a failure 40 signal the absence of a failure.

The control method is, for example, carried out following a change of state of the coupling device 18 to decouple the electric machine 16 following a failure of the electric machine 16, or when implementing a function test of the coupling device 18 or to ensure that the coupling device 18 is still in the operating state controlled by the control device 20.

It is now assumed that the turbomachine 4 is stopped, for example the aircraft 2 is on the ground.

The method begins with a step 56 of controlling the electric machine 16 in motor mode such that the electric machine 16 uses an electrical power to generate a mechanical rotational power.

Preferably, the control device 20 controls the electric machine 16 in motor mode such that the electric machine 16 generates sufficient mechanical power to rotate the rotor shaft of the electric machine 16, but insufficient to rotate the rotary shaft 6.

The steps 42, 44 and 46 described above are then performed.

During the first comparison step 48, the rotational speed of the rotary shaft 6 is zero. The time evolution profile comprises the rotational speed of the decoupled electric machine 16.

The method continues in steps 50, 52, 54 as described above.

When the control device 20 controls the electric machine 16 in motor mode such that the electric machine 16 generates sufficient mechanical power to rotate the rotor shaft of the electric machine 16 and to rotate the rotary shaft 6, during a step 58 of blocking the rotation of the rotary shaft 6, a propeller brake is, for example, activated to prevent rotation of the rotary shaft 6.

The method then continues to step 56.

The blocking step 58 also makes it possible to prevent an incorrect assessment of the operating state of the coupling device 18 when the rotary shaft 6 is rotated by windmilling.

By adjusting the value of the detection threshold according to the control parameter P, the operating deviation and the rotational speed of the electric machine 16, the operating conditions of the turbomachine 4 can be taken into account in order to improve the detection of a failure of the coupling device 18.

1. Method for controlling the operation of a coupling device for an aircraft turbomachine, the turbomachine comprising a rotary shaft and an electric machine, the coupling device being configured to connect a rotor shaft of the electric machine to the rotary shaft and having two operating states, a coupled state so as to secure the rotor shaft and the rotary shaft and a decoupled state so as to separate the rotor shaft and the rotary shaft, the method comprising the steps of:
determining a control state of the coupling device delivered in the form of a control command in the coupled state or in the decoupled state of the coupling device;
determining the rotational speed of the electric machine;
determining the rotational speed of the rotary shaft;
a first comparison of the determined rotational speed of the electric machine with a time evolution profile of the rotational speed of the electric machine determined from the rotational speed of the rotary shaft and the control state of the coupling device, the first comparison being carried out to determine an operating deviation;
a second comparison of the operating deviation with a detection threshold; and
according to the result of the second comparison step, identifying the existence or absence of a failure of the coupling device;
wherein the second comparison step comprises determining the value of the detection threshold from at least one control parameter, the operating deviation and the rotational speed of the electric machine.

2. Method according to claim 1, wherein the control parameter is selected from the outside temperature, the altitude of the aircraft and a parameter representative of a type of failure of the electric machine.

3. Method according to claim 1, wherein the first comparison step comprises a prior step of determining a chart of time evolution profiles of the rotational speed of the electric machine as a function of the rotational speed of the rotary shaft and the control state of the coupling device.

4. Method according to claim 1, wherein the second comparison step comprises calculating the gradient of the operating deviation and a step of calculating the gradient of the time evolution profile prior to the second comparison step, the value of the detection threshold being determined from the control parameter, the gradient of the operating deviation, and the gradient of the determined rotational speed of the electric machine.

5. Method according to claim 1, comprising a step of delaying the result of the second comparison step.

6. Method according to claim 1, comprising prior to the step of determining the rotational speed of the electric machine, a control of the electric machine in motor mode when the turbomachine is stopped.

7. Method according to claim 6, comprising blocking the rotation of the rotary shaft when the electric machine operates in motor mode.

8. Module for controlling the operation of a coupling device for an aircraft turbomachine, the turbomachine comprising a rotary shaft and an electric machine, the coupling device being configured to connect a rotor shaft of the electric machine to the rotary shaft and having two operating states, a coupled state so as to secure the rotor shaft and the rotary shaft and a decoupled state so as to separate the rotor shaft and the rotary shaft, the module comprising:
first determining means configured to determine a control state of the coupling device delivered in the form of a control command in the coupled state or in the decoupled state of the coupling device;
second determining means configured to determine the rotational speed of the electric machine;
third determining means configured to determine the rotational speed of the rotary shaft;
first comparison means configured to compare the rotational speed of the electric machine with a time evolution profile of the rotational speed of the electric machine determined from the rotational speed of the rotary shaft and the control state of the coupling device, the first comparison means being configured to determine an operating deviation;
second comparison means configured to compare the operating deviation with a detection threshold; and
means for determining a failure configured to identify the existence of a failure or absence of a failure of the coupling device according to the result delivered by the second comparison means;
wherein the second comparison means are also configured to determine the value of the detection threshold from at least one control parameter, the operating deviation and the rotational speed of the electric machine.

9. Aircraft turbomachine comprising a rotary shaft, an electric machine, and a coupling device configured to connect a rotor shaft of the electric machine to the rotary shaft and having two operating states, a coupled state so as to secure the rotor shaft and the rotary shaft and a decoupled state so as to separate the rotor shaft and the rotary shaft, wherein it comprises a control module according to claim 8.

10. Aircraft comprising a turbomachine according to claim 9.
